(19) United States
(12) Patent Application Publication
(10) Pub. No.: US 2014/0146760 A1
(43) Pub. Date: May 29, 2014

(54) COMMUNICATION APPARATUS, CONTROL METHOD THEREFOR AND COMPUTER-READABLE STORAGE MEDIUM

(71) Applicant: Canon Kabushiki Kaisha, Tokyo (JP)

(72) Inventor: Tsuyoshi Terao, Yokohama-shi (JP)

(73) Assignee: Canon Kabushiki Kaisha, Tokyo (JP)

(21) Appl. No.: 14/060,993

(22) Filed: Oct. 23, 2013

(30) Foreign Application Priority Data
Nov. 28, 2012 (JP) 2012-260338

(51) Int. Cl. H04W 76/02; H04W 72/04; H04W 84/12

(52) U.S. Cl. CPC H04W 76/023; H04W 84/12; H04W 72/0453
USPC 370/329

(57) ABSTRACT

A communication apparatus serves as a provision apparatus for providing communication parameters if a user operation for direct communication with another communication apparatus is detected while being connected to the network of a base station.

### BACKGROUND OF THE INVENTION

1. Field of the Invention

The present invention relates to a communication apparatus including a wireless unit connectable to a plurality of networks, a control method for the communication apparatus, and a computer-readable storage medium.

2. Description of the Related Art

In wireless communication represented by a wireless LAN complying with the IEEE802.11 standard series, an infrastructure mode in which an access point (base station) controls a network and an ad hoc mode in which a terminal apparatus autonomously creates a network are defined. Furthermore, there has been proposed a method of communicating with another terminal apparatus in the ad hoc mode while connecting to a base station in the infrastructure mode, by the support of a multi-BSS (Basic Service Set) function capable of creating a plurality of networks by one terminal apparatus (see, for example, Japanese Patent Laid-Open No. 2005-64552).

A case in which communication parameter setting between terminals is performed in a multi-BSS-compatible terminal apparatus by a simple user operation such as pressing of a physical button provided in the apparatus will be described. By performing communication parameter setting between a first terminal apparatus and a second terminal apparatus, an ad hoc network can be created between the two terminals. If, however, communication parameter setting is performed while the two terminal apparatuses are connected to one access point, a communication path via the access point and a direct communication path between the terminal apparatuses are generated, resulting in unwanted consumption of resources.

### SUMMARY OF THE INVENTION

The present invention provides a communication technique capable of adaptively communicating with a plurality of networks by effectively using resources.

To achieve the above object, a communication apparatus according to the present invention has the following arrangement. That is, a communication apparatus comprising: a provision unit configured to provide, to another communication apparatus, communication parameters for direct communication between the communication apparatus and the other communication apparatus; an acceptance unit configured to accept, from another communication apparatus, communication parameters for direct communication between the communication apparatus and the other communication apparatus; and a detection unit configured to detect a user operation for direct communication between the communication apparatus and another communication apparatus, wherein the communication apparatus serves as a provision apparatus for providing the communication parameters by the provision unit if the detection unit detects the user operation while being connected to a network of a base station.

According to the present invention, it is possible to provide a communication technique capable of adaptively communicating with a plurality of networks by effectively using resources.

Further features of the present invention will become apparent from the following description of exemplary embodiments (with reference to the attached drawings).

### BRIEF DESCRIPTION OF THE DRAWINGS

FIG. 1 is a block diagram showing a communication apparatus according to the first embodiment;

FIG. 2 is a block diagram showing the software arrangement of the communication apparatus according to the first embodiment;

FIG. 3 is a view showing a network configuration according to the first embodiment;

FIG. 4 is a flowchart illustrating a communication parameter setting operation by the communication apparatus according to the first embodiment;

FIG. 5 is a sequence chart showing an operation between communication terminals and an access point according to the first embodiment;

FIG. 6 is a sequence chart showing an operation between the communication terminals and the access point according to the first embodiment;

FIG. 7 is a block diagram showing the software arrangement of a communication apparatus according to the second embodiment;

FIG. 8 is a view showing a network configuration according to the second embodiment;

FIG. 9 is a flowchart illustrating a communication parameters setting operation by the communication apparatus according to the second embodiment; and

FIG. 10 is a sequence chart showing an operation between communication terminals and an access point according to the second embodiment.

### DESCRIPTION OF THE EMBODIMENTS

Embodiments of the present invention will be described in detail below with reference to the accompanying drawings.

### First Embodiment

Although a case in which a wireless LAN system complying with the IEEE802.11 standard series is used will be explained below, a communication mode is not necessarily limited to a wireless LAN complying with the IEEE802.11 standard.

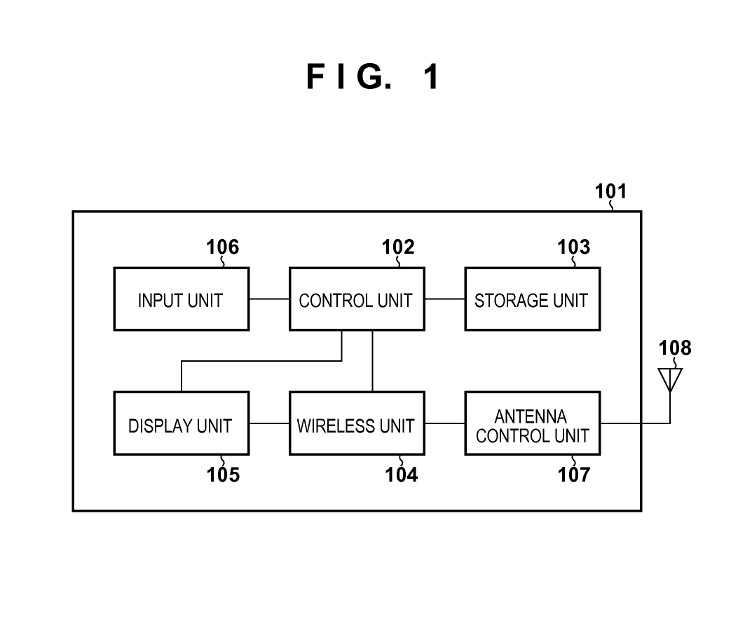

A hardware arrangement according to the first embodiment will be described. FIG. 1 is a block diagram showing an example of the arrangement of each apparatus (to be described later).

Reference numeral 101 denotes an overall communication apparatus; and 102, a control unit which controls the overall apparatus by executing computer programs stored in a storage unit 103. The control unit 102 is implemented by a computer such as a CPU or MPU. The control unit 102 also controls a communication parameter automatic setting system with another communication apparatus.

The storage unit 103 stores computer programs for control executed by the control unit 102, and various kinds of information such as communication parameters. Various operations (to be described later) are performed when the control unit 102 executes the computer programs stored in the storage unit 103. Note that a memory such as a ROM or RAM, or a storage device such as a flexible disk, hard disk, optical disk, magnetooptical disk, CD-ROM, CD-R, magnetic tape, non-volatile memory card, or DVD is usable as the storage unit 103.

Reference numeral 104 denotes a wireless unit (wireless interface) for wireless communication; and 105, a display unit for performing various display operations. The display unit 105 has a function capable of outputting visually perceivable information by a display device like an LCD or LED, or a function capable of outputting a sound by a sound output apparatus such as a loudspeaker. Reference numeral 106 denotes an input unit which is used by the user to perform various input operations and includes physical buttons and switches; and 107, an antenna control unit for controlling the operation of an antenna 108.

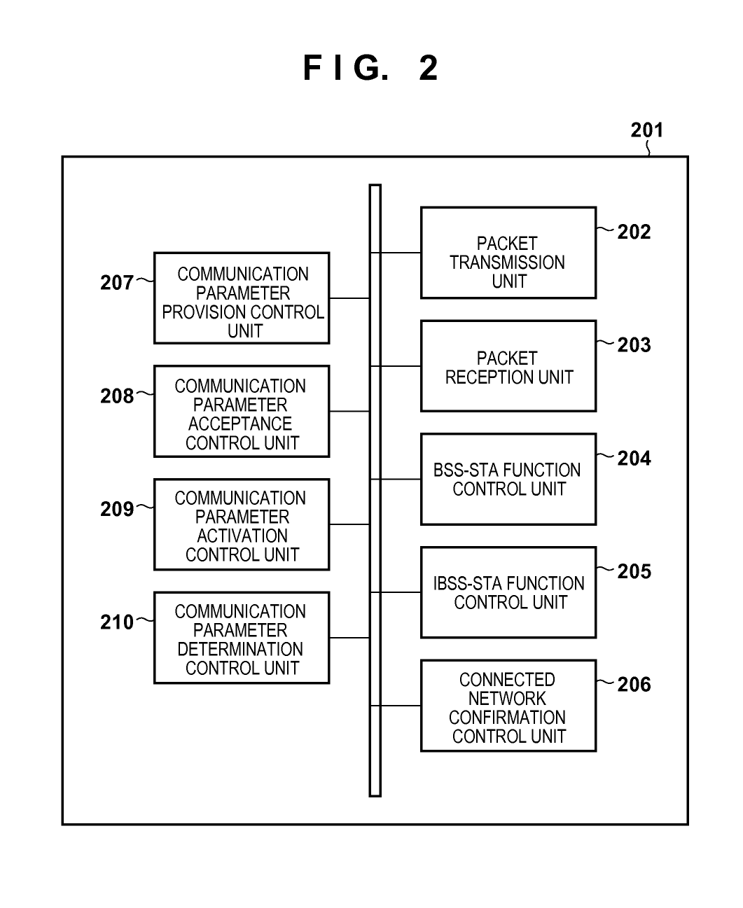

FIG. 2 shows an example of the arrangement of software functional blocks executed by the communication apparatus serving as a communication terminal which supports a multi-BSS function in a processing operation (to be described later).

Reference numeral 201 denotes an overall communication apparatus; and 202, a packet transmission unit which transmits packets associated with various communication processes. The packet transmission unit 202 transmits each signal (to be described later). Reference numeral 203 denotes a packet reception unit which receives packets associated with various communication processes. The packet reception unit 203 receives each signal (to be described later).

Reference numeral 204 denotes a BSS-STA function control unit which controls an operation as a terminal station (STA) in the infrastructure mode (BSS). The BSS-STA function control unit 204 performs a processing operation as the infrastructure mode terminal station in a wireless LAN network such as transmission/reception of a search signal by the access point (base station) and processing of connecting with the base station. Reference numeral 205 denotes an IBSS-STA function control unit which controls an operation as a terminal station (STA) in the ad hoc mode (IBSS). The IBSS-STA function control unit 205 performs a processing operation (to be described later) as the ad hoc mode terminal station.

Reference numeral 206 denotes a connected network confirmation control unit which confirms whether the communication apparatus is currently connected with a network. The connected network confirmation control unit 206 executes network connection confirmation processing (to be described later). Reference numeral 207 denotes a communication parameter provision control unit which provides communication parameters to a partner apparatus (serves as a provision apparatus); and 208, a communication parameter acceptance control unit which accepts communication parameters from a partner apparatus (serves as an acceptance apparatus).

Note that the communication parameter provision control unit 207 or the communication parameter acceptance control unit 208 provides or accepts communication parameters necessary for wireless communication, such as an SSID as a network identifier for identifying a wireless network, channel information indicating a frequency channel which forms a wireless network, an encryption method, an encryption key, an authentication method, and an authentication key. The encryption method is used to perform wireless encryption communication. The encryption key is used to perform wireless encryption communication. The authentication method is used in wireless communication. The authentication key is used to perform authentication processing in wireless communication.

Reference numeral 209 denotes a communication parameter activation control unit which detects the activation of communication parameter setting processing. The communication parameter activation control unit 209 executes control associated with a user operation including, for example, user button operation detection, menu selection operation detection, and near-field operation detection by NFC (Near Field Communication) in the input unit 106. Reference numeral 210 denotes a communication parameter determination control unit which determines whether to activate the communication parameter provision control unit 207 or the communication parameter acceptance control unit 208 in communication parameter setting. The communication parameter determination control unit 210 also detects another apparatus which is executing a communication parameter setting operation.

The functional blocks shown in FIG. 2 are correlated with each other in a software or hardware manner. Each functional block may be formed as hardware. The above functional blocks are merely examples. A plurality of functional blocks may constitute one functional block, or any one of the functional blocks may be divided into a plurality of blocks each executing a function.

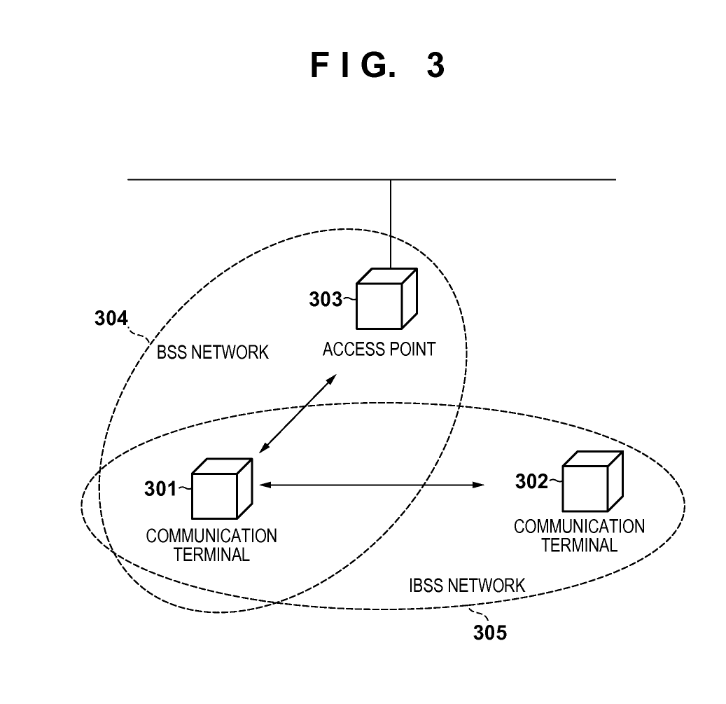

FIG. 3 is a view showing a network including communication terminals 301 and 302, and an access point (to be referred to as an AP hereinafter) 303. Each of the communication terminals 301 and 302 has the arrangements shown in FIGS. 1 and 2. The communication terminal 301 is currently connected to a BSS network 304 managed by the AP 303. The communication terminals 301 and 302 are connected by a direct IBSS network 305 serving as a direct communication network between the communication terminals.

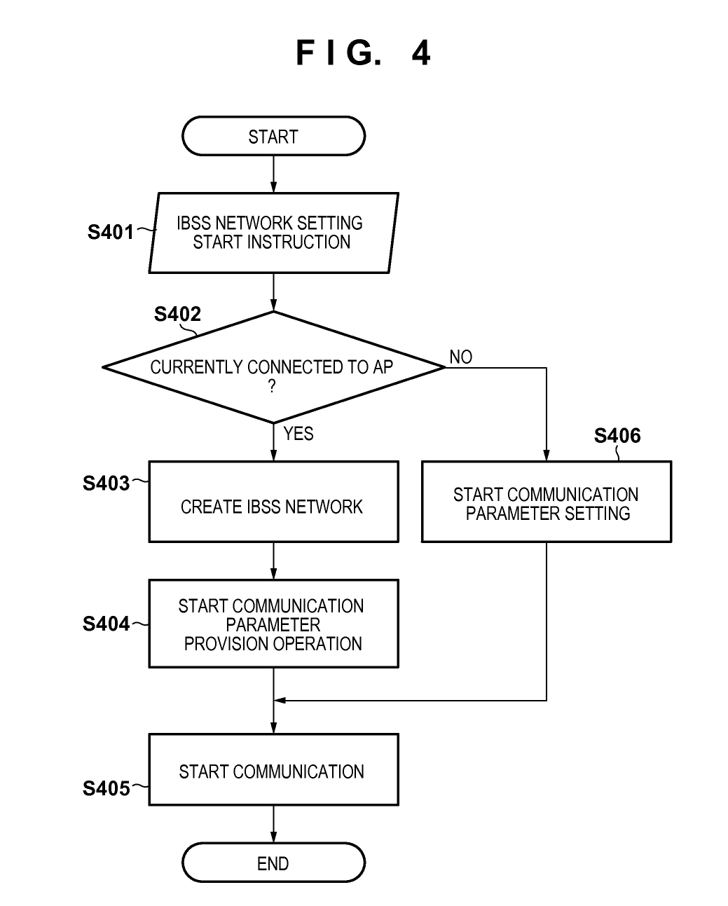

FIG. 4 is a flowchart illustrating an operation when the start of IBSS network setting of the communication terminals 301 and 302 is instructed. Processing shown in FIG. 4 is performed when the control unit 102 reads out a computer program stored in the storage unit 103, and executes it.

After the activation of the communication terminal, the communication parameter activation control unit 209 detects a user instruction to start IBSS network setting from the input unit 106 (step S401). The connected network confirmation control unit 206 determines whether the communication terminal is currently connected to the AP (step S402). This determination is made by, for example, referring to a connection state (for example, an unconnected state, connection processing state, or connected state) held by the BSS-STA function control unit 204.

If it is determined that the communication terminal is currently connected to the AP (YES in step S402), the IBSS-STA function control unit 205 creates a new IBSS network using the same frequency channel as that used by the currently connected AP (step S403). The communication parameter provision control unit 207 starts a parameter provision operation (step S404). Upon completion of the parameter provision operation on the same frequency channel as that of the currently connected AP for the other communication terminal 302 which has started a communication parameter acceptance operation, the communication terminal 301 starts communication with the communication terminal 302 using provided communication parameters (step S405). In this case, the provided communication parameters include information of the same frequency channel as that currently connected with the AP.

On the other hand, if it is determined that the communication terminal is not currently connected to the AP (NO in step S402), the IBSS-STA function control unit 205 arbitrarily selects a usable frequency channel, and creates a new IBSS network. Furthermore, the communication parameter determination control unit 210 activates the communication parameter provision control unit 207 or the communication parameter acceptance control unit 208, and starts communication parameter setting (step S406). Upon completion of the communication parameter acceptance operation or communication parameter provision operation, the communication terminal starts communication with the communication terminal 302 using the communication parameters (step S405).

Note that in step S406, the communication parameter determination control unit 210 may transmit a search request, and activate, if it receives a response from a communication terminal having a communication parameter provision function, the communication parameter acceptance control unit 208, or activate, if it receives no response, the communication parameter provision control unit 207. Alternatively, the communication parameter provision control unit 207 and the communication parameter acceptance control unit 208 may be alternately activated at predetermined intervals, and then a communication parameter provision operation or communication parameter acceptance operation may be selectively performed together with the communication terminal 302.

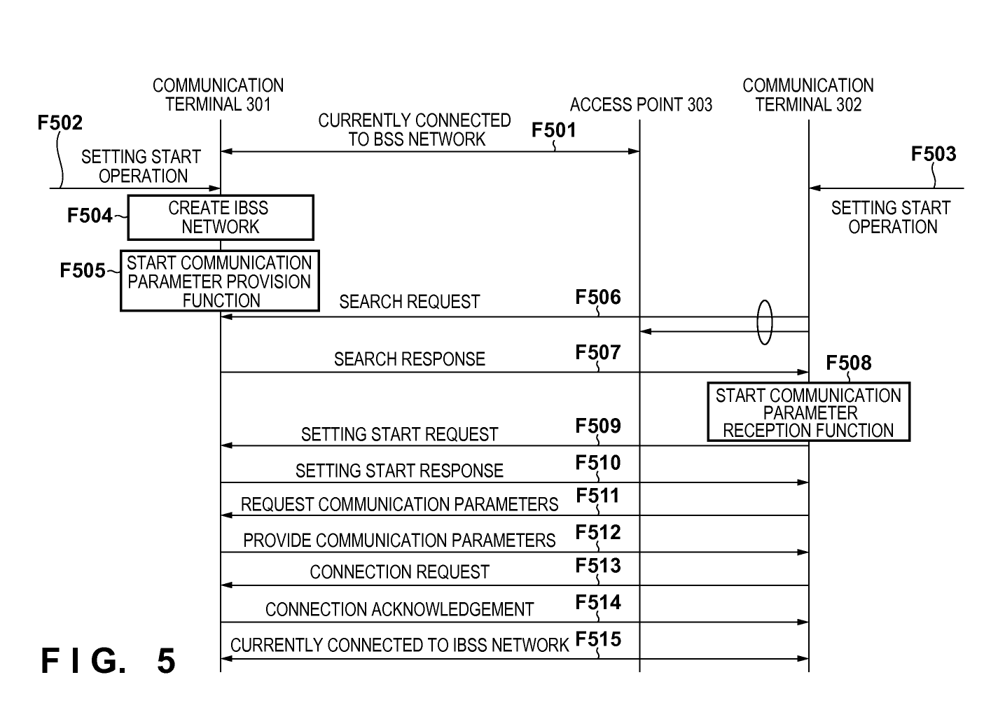

FIG. 5 is a sequence chart showing connection processing when a user setting operation for creating an IBSS network is performed in each of the communication terminals 301 and 302 while the communication terminal 301 is connected to the AP 303. The communication terminal 301 is currently connected with the BSS network of the AP 303 (F501). Each of the communication terminals 301 and 302 accepts a setting start operation by the user (F502 and F503). Since the communication terminal 301 is currently connected to the BSS network, it creates an IBSS network using the same frequency channel as that of the BSS network (F504). The communication terminal 301 stands by for a communication parameter reception request by starting a communication parameter provision function (the communication parameter provision control unit 207) (F505).

The communication terminal 302 transmits a search request (for example, a Probe Request signal) including an information element indicating a communication parameter setting processing request, and searches for a peripheral apparatus which has started communication parameter setting processing (F506).

In response to the search request from the communication terminal 302, the communication terminal 301 returns, to the communication terminal 302, a search response (for example, a Probe Response signal) including an information element indicating that communication parameter provision processing is in progress (F507).

If the communication terminal 302 receives the search response from the communication terminal 301, and determines that the communication parameter provision processing is in progress, it starts a communication parameter reception function (the communication parameter acceptance control unit 208) (F508). The communication terminal 302 transmits a communication parameter setting start request to the communication terminal 301 (F509).

In response to the communication parameter setting start request from the communication terminal 302, the communication terminal 301 transmits a setting start response to the communication terminal 302 (F510).

Upon receiving the setting start response from the communication terminal 301, the communication terminal 302 transmits a communication parameter request to the communication terminal 301 (F511).

Upon receiving the communication parameter request from the communication terminal 302, the communication terminal 301 provides communication parameters for creating an IBSS network to the communication terminal 302 (F512).

The communication terminal 302 selects an SSID and security scheme in the IBSS network and sets a security key based on the communication parameters accepted from the communication terminal 301, and then transmits a connection request to the communication terminal 301 to start security communication (F513).

The communication terminal 301 sends a security communication response, and returns a connection acknowledgement to the communication terminal 302 (F514).

With the above sequence, the communication terminals 301 and 302 are connected on the IBSS network (F515).

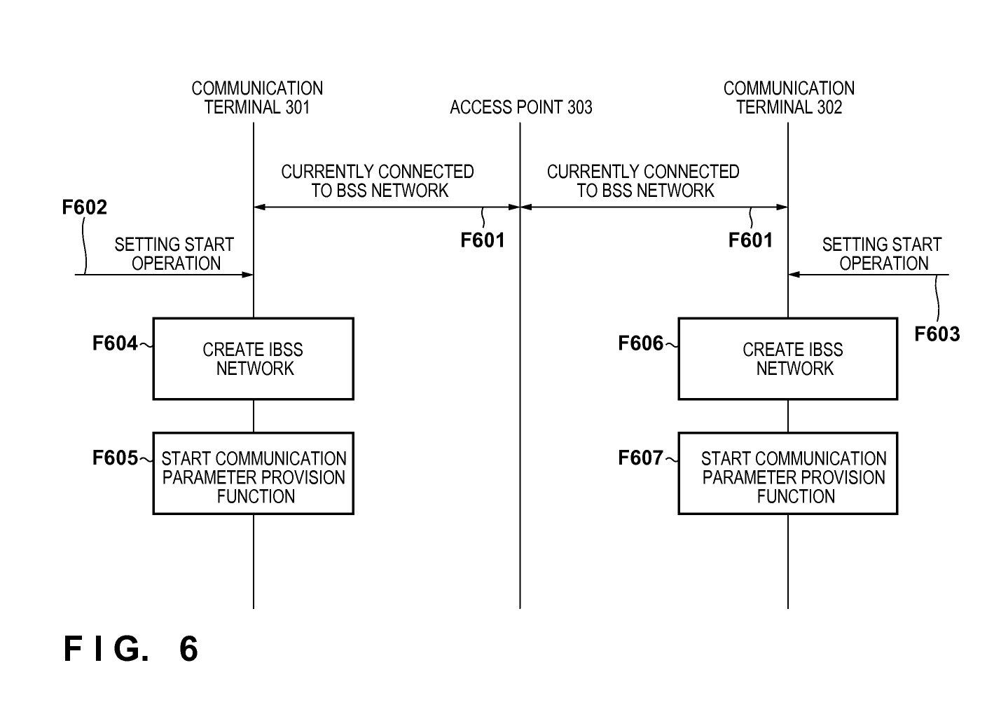

On the other hand, FIG. 6 is a sequence chart showing connection processing when a user setting operation is performed in each of the communication terminals 301 and 302 while they are connected to the AP 303.

The communication terminals 301 and 302 are currently connected to the BSS network of the AP 303 (F601). Each of the communication terminals 301 and 302 accepts a setting start operation by the user (F602 and F603).

Since the communication terminal 301 is currently connected to the BSS network, it creates an IBSS network (F604). The communication terminal 301 then stands by for reception of a communication parameter reception request by starting the communication parameter provision function (F605).

Similarly, since the communication terminal 302 is currently connected to the BSS network, it creates an IBSS network (F606). The communication terminal 302 then stands by for reception of a communication parameter reception request by starting the communication parameter provision function (F607).

Each of the communication terminals 301 and 302 stands by for a communication parameter reception request. Therefore, if parameter provision processing is not completed within a predetermined time, the communication parameter provision function of each communication terminal is deactivated upon time-out.

That is, if the parameter provision processing is not completed within a predetermined time after each of the communication terminals 301 and 302 enters a state in which it stands by for a communication parameter reception request, its communication parameter provision function is deactivated. This can prevent IBSS network connection between the two communication terminals, thereby effectively using frequency resources.

As described above, according to the first embodiment, a multi-BSS-compatible communication terminal which can simultaneously connect to (create) a plurality of networks can suppress creation of an unnecessary network, and reduce power consumption and network resources to be used.

### Second Embodiment

In the first embodiment, control is performed so not to create an IBSS network between communication terminals which support a multi-BSS function and are currently connected to a BSS network. To the contrary, in the second embodiment, an arrangement will be described in which control is performed to create an IBSS network between apparatuses which support a multi-BSS function if a request for a specific communication service is received even though the apparatuses are currently connected to a BSS network.

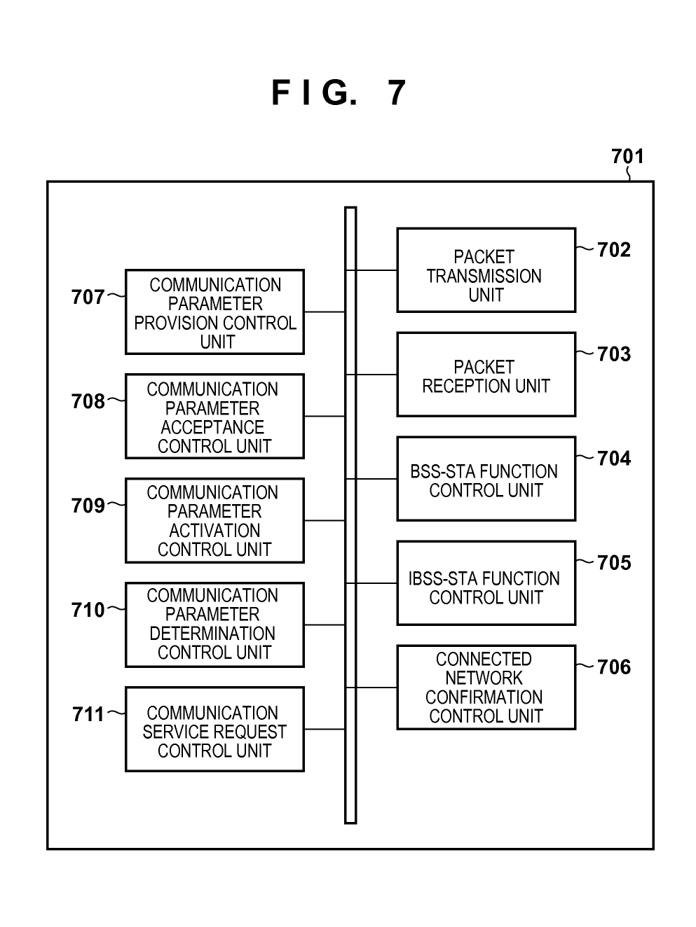

FIG. 7 shows an example of the arrangement of software functional blocks executed by an apparatus serving as a terminal apparatus which supports a multi-BSS function in a processing operation (to be described later).

Reference numeral 701 denotes an overall communication apparatus. Components 702 to 710 correspond to the components 202 to 210 in the first embodiment and have the same functions as those of the components 202 to 210, respectively, and a description thereof will be omitted. Reference numeral 711 denotes a communication service request control unit for sending a communication service request to a partner terminal, and determining a communication service request from the partner terminal.

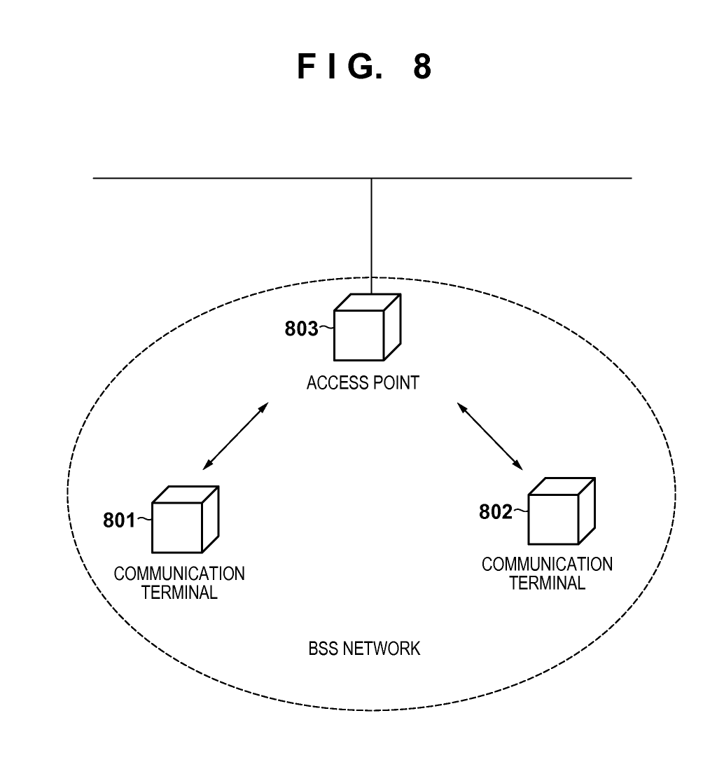

FIG. 8 is a view showing a network including communication terminals 801 and 802 and an access point (AP) 803. Each of the communication terminals 801 and 802 has the arrangements shown in FIGS. 1 and 7 described above. The communication terminals 801 and 802 are connected to a BSS network managed by the AP 803.

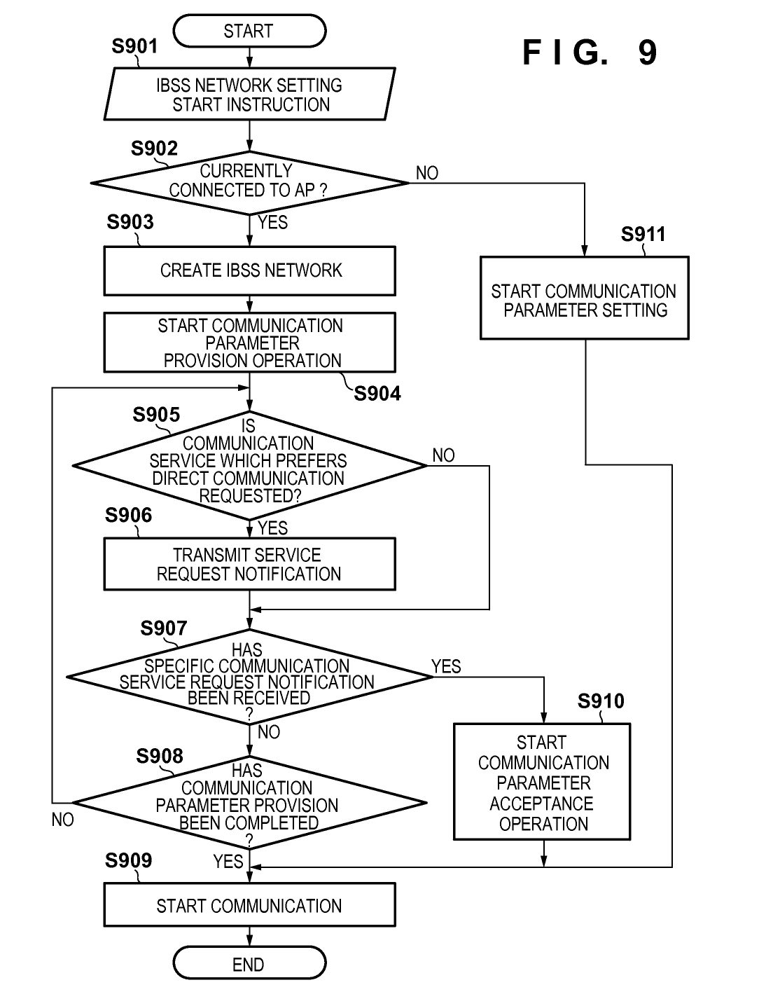

FIG. 9 is a flowchart illustrating an operation when the start of IBSS network setting of the communication terminals 801 and 802 is instructed. Note that processes in steps S901 to S904 and S911 correspond to those in steps S401 to S404 and S406 of FIG. 4, respectively, and a description thereof will be omitted.

Upon creating an IBSS network, the communication terminal 801 determines whether a communication service which prefers direct communication between communication terminals over communication via the AP is requested (step S905). For example, a service which requests packet transmission/reception with a smaller delay is a service which prefers direct communication. Furthermore, for example, a service which transmits real-time stream data from a video camcorder to a digital TV is also a service which prefers direct communication.

If it is determined that a communication service which prefers direct communication is requested (YES in step S905), the packet transmission unit 702 broadcasts a service request notification (service request notification packet) indicating the communication service requested by the self terminal (step S906). The service request notification packet includes identification information of the BSS network to which the self terminal is currently connected (for example, information such as a BSSID indicating that the self terminal is connected to the same BSS network).

Upon receiving the service request notification, the communication service request control unit 711 determines based on the information included in the service request notification whether that notification is a specific service request notification (step S907). If, for example, the notification includes the same BSS network identification information as that of the BSS network to which the self terminal is currently connected and communication quality included in the service request notification is satisfied, the unit 711 determines that the received notification is a specific service request notification.

If the received notification is a specific service request notification (YES in step S907), the communication parameter determination control unit 710 activates the communication parameter acceptance control unit 708 (step S910).

On the other hand, if the received notification is not a specific service request notification (NO in step S907), it is determined whether a communication parameter provision operation has been completed within a predetermined time (step S908). If the communication parameter provision operation has been completed within the predetermined time (YES in step S908), the communication terminal 801 starts communication with the communication terminal 802 using communication parameters provided to the communication terminal 802.

On the other hand, if the communication parameter provision operation has not been completed within the predetermined time (NO in step S908), the communication service request control unit 711 returns to step S905 to transmit a service request notification again and stand by for reception of a specific service request notification or completion of the communication parameter provision operation.

Note that determination in step S905 whether a communication service which prefers direct communication is requested may be made based on the index value of the requested communication quality or the type of application to be executed. The service request notification transmitted in step S906 may include at least one of the index value of the requested communication quality, device type, application type, the same channel information as that of the channel of the currently connected BSS network or identification information of the currently connected BSS network, and the like.

A condition under which it is determined in step S907 whether a specific service request notification has been received may be as follows. For example, (1) communication quality requested in the service request notification can be satisfied, (2) a requested application can be executed, and (3) the BSS network currently connected with the communication terminal as a request source is different from the connection destination BSS network of the self terminal.

Transmission of the service request notification in step S906 is not limited to wireless broadcast transmission. The service request notification may be unicast or broadcast using the BSS network of the access point. In this case, it is apparent that the service request notification is transmitted to only devices which are currently connected to the same BSS network.

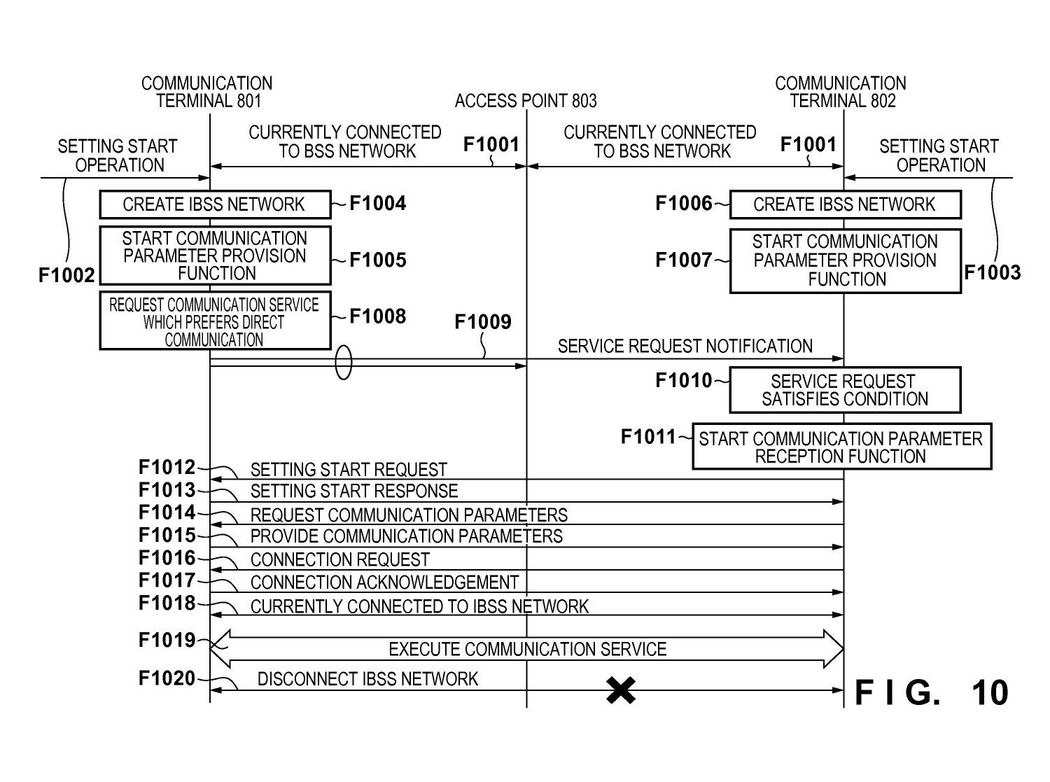

FIG. 10 is a sequence chart showing connection processing when a user setting operation is performed in each of the communication terminals 801 and 802 while they are connected to the AP 803. Both the communication terminals 801 and 802 are connected to the BSS network of the AP 803 (F1001). Each of the communication terminals 801 and 802 accepts a setting start operation by the user (F1002 and F1003).

Since the communication terminal 801 is currently connected to the BSS network, it creates an IBSS network (F1004). The communication terminal 801 then stands by for reception of a communication parameter reception request by starting a communication parameter provision function (F1005).

Similarly, since the communication terminal 802 is currently connected to the BSS network, it creates an IBSS network (F1006). The communication terminal 802 then stands by for reception of a communication parameter reception request by starting a communication parameter provision function (F1007).

The communication terminal 801 determines that a communication service requested by itself prefers direct communication between communication terminals over communication via the AP 803 (F1008). In this case, the communication terminal 801 broadcasts (performs packet communication) a service request notification for the communication service on the same channel as that of the currently connected BSS network (F1009).

Since the communication terminal 802 is currently connected to the same BSS network as that of the communication terminal 801, and stands by for arrival of a packet on the same channel, it can receive the service request notification transmitted by the communication terminal 801. Upon receiving the notification, the communication terminal 802 determines, based on the contents of the service request notification, that it is currently connected to the same BSS network and it can provide the requested communication service (F1010). In this case, the communication terminal 802 starts a communication parameter reception function (F1011). The communication terminal 802 transmits a communication parameter setting start request to the communication terminal 801 (F1012).

In response to the setting start request from the communication terminal 802, the communication terminal 801 transmits a setting start response to the communication terminal 802 (F1013).

Upon receiving the setting start response from the communication terminal 801, the communication terminal 802 transmits a communication parameter request to the communication terminal 801 (F1014).

Upon receiving the communication parameter request from the communication terminal 802, the communication terminal 801 provides communication parameters for creating an IBSS network to the communication terminal 802 (F1015).

The communication terminal 802 selects an SSID and security scheme in the IBSS network and sets a security key based on the communication parameters accepted from the communication terminal 801, and then transmits a request to the communication terminal 801 to start security communication (F1016).

The communication terminal 801 sends a security communication response, and returns a connection acknowledgement to the communication terminal 802 (F1017).

With the above sequence, both the communication terminals 801 and 802 are connected on the IBSS network even if they are connected to the BSS network of the AP 803 (F1018). The communication terminals 801 and 802 execute the communication service using the IBSS network (F1019). Upon completion of execution of the communication service using the IBSS network, the communication terminals 801 and 802 disconnect only the IBSS network (F1020). At this time, neither the communication terminal 801 nor 802 cancels connection to the BSS network.

As described above, according to the second embodiment, even though multi-BSS-compatible communication terminals each of which can simultaneously connect to a plurality of networks are currently connected to an access point, a direct communication network is created between the terminals if necessary to execute a service. This can improve the user convenience.

That is, it is possible to create an IBSS network when a communication service which prefers direct communication is requested, even though two communication terminals are currently connected to a BSS network, and start their respective communication parameter provision functions. This can improve the connectivity and convenience.

Although the embodiments of the present invention have been described, they are merely examples for description of the present invention, and do not limit the scope of the present invention. Various modifications can be made to the embodiments without departing from the spirit of the present invention. Furthermore, in the aforementioned embodiments, a wireless LAN complying with the IEEE802.11 standard has been explained as an example. The present invention, however, is not limited to this. For example, the present invention may be implemented in another wireless medium such as wireless USB, MBOA, Bluetooth®, UWB, or ZigBee. Note that MBOA is an abbreviation for Multi Band OFDM Alliance. UWB includes wireless USB, wireless 1394, and WINET.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-260338, filed Nov. 28, 2012, which is hereby incorporated by reference herein in its entirety.

What is claimed is:

1. A communication apparatus comprising:
a provision unit configured to provide, to another communication apparatus, communication parameters for direct communication between said communication apparatus and the other communication apparatus;
an acceptance unit configured to accept, from another communication apparatus, communication parameters for direct communication between said communication apparatus and the other communication apparatus; and
a detection unit configured to detect a user operation for direct communication between said communication apparatus and another communication apparatus,
wherein said communication apparatus serves as a provision apparatus for providing the communication parameters by said provision unit if said detection unit detects the user operation while being connected to a network of a base station.

2. The apparatus according to claim 1, wherein
if provision of the communication parameters is not completed within a predetermined time after an operation as the provision apparatus starts, the operation as the provision apparatus is terminated.

3. The apparatus according to claim 1, wherein
the communication parameters provided by said provision unit include information indicating the same frequency channel as that used by the network of the base station or information for identifying the network of the base station.

4. The apparatus according to claim 1, wherein
if said communication apparatus is not connected to the network of the base station, one of provision processing by said provision unit and acceptance processing by said acceptance unit is selectively executed.

5. The apparatus according to claim 1, further comprising
a reception unit configured to receive, from the other communication apparatus, a service request notification indicating a request of a communication service,
wherein if it is determined that the service request notification received by said reception unit indicates a specific communication service, said communication apparatus serves as an acceptance apparatus for accepting the communication parameters by said acceptance unit.

6. The apparatus according to claim 5, wherein
the service request notification includes at least one of an index value of requested communication quality, a device type of the self apparatus, a type of application requested to be executed, identification information of the currently connected network of the base station.

7. The apparatus according to claim 5, wherein
the service request notification is transmitted by packet communication via the currently connected network of the base station.

8. The apparatus according to claim 5, wherein
the service request notification is transmitted by a packet broadcast on the same channel as that of the currently connected network of the base station.

9. The apparatus according to claim 1, wherein the communication parameters provided by said provision unit include any one of a network identifier for identifying a wireless network, information indicating a frequency channel forming a wireless network, an encryption method in performing wireless encryption communication, an encryption key for wireless encryption communication, an authentication method used in wireless communication, and an authentication key for authentication processing in performing wireless communication.

10. The apparatus according to claim 1, further comprising
a wireless unit configured to perform wireless communication complying with the IEEE802.11 standard,
wherein the communication parameters provided by said provision unit include communication parameters for wireless communication using said wireless unit.

11. A control method for a communication apparatus including a wireless unit, comprising:
a provision step of providing, to another communication apparatus, communication parameters for direct communication between the communication apparatus and the other communication apparatus using the wireless unit;
an acceptance step of accepting, from another communication apparatus, communication parameters for direct communication between the communication apparatus and the other communication apparatus; and
a detection step of detecting a user operation for direct communication between the communication apparatus and another communication apparatus,
wherein the communication apparatus serves as a provision apparatus for providing the communication parameters in the provision step if the user operation is detected in the detection step while being connected to a network of a base station.

12. A computer-readable storage medium storing a program for causing a computer to perform control of a communication apparatus, the program causes the computer to function as
a provision unit configured to provide, to another communication apparatus, communication parameters for direct communication between the communication apparatus and the other communication apparatus,
an acceptance unit configured to accept, from another communication apparatus, communication parameters for direct communication between the communication apparatus and the other communication apparatus,
a detection unit configured to detect a user operation for direct communication between the communication apparatus and another communication apparatus, and
a control unit configured to control to serve as a provision apparatus for providing the communication parameters by the provision unit if the detection unit detects the user operation while being connected to a network of a base station.
